(19) United States
(12) Patent Application Publication
(10) Pub. No.: US 2021/0095092 A1
(43) Pub. Date: Apr. 1, 2021

(54) PESU PARTICLE FOAMS FOR APPLICATIONS IN AVIATION INTERIORS

(71) Applicant: Evonik Operations GmbH, Essen (DE)

(72) Inventors: Christian Traßl, Warmensteinach (DE); Denis Holleyn, Hofheim am Taunus (DE); Kay Bernhard, Cheshire, CT (US)

(73) Assignee: Evonik Operations GmbH, Essen (DE)

(21) Appl. No.: 15/733,134

(22) PCT Filed: Nov. 19, 2018
(86) PCT No.: PCT/EP2018/081689

§ 371 Date: May 26, 2020

(30) Foreign Application Priority Data
Nov. 27, 2017 (EP) 17203688.1

(51) Int. Cl. C08J 9/18; C08J 9/00; C08J 9/12; C08J 9/14

(52) U.S. Cl. CPC C08J 9/18; C08J 9/008; C08J 9/0085; B82Y 30/00; C08J 9/141; C08J 9/142; C08J 9/125

(57) ABSTRACT

Polymer foams based on polyethersulfone (PESU) fulfil the legal specifications demanded by the aviation industry for aircraft interiors. Specifically the demands on fire characteristics, stability to media and mechanical properties constitute a great challenge here. According to the related art, suitable polymer foams are produced as semifinished products. Reprocessing to give shaped articles is uneconomic in terms of time and material exploitation, for example by virtue of large amounts of cutting waste. The problem is solved by the material which is suitable in principle can be processed to give particle foam mouldings. These mouldings can be produced without reprocessing in short cycle times and hence economically. Furthermore, this gives rise to new means of functional integration, for example by direct incorporation of inserts etc. in the foam, and with regard to freedom in terms of design.

### FIELD OF THE INVENTION

Polymer foams based on polyethersulfone (PESU) fulfil the legal specifications demanded by the aviation industry for aircraft interiors. Specifically the demands on fire characteristics, stability to media and mechanical properties constitute a great challenge here. According to the prior art, suitable polymer foams are produced as semifinished products. Reprocessing to give shaped articles is uneconomic in terms of time and material exploitation, for example by virtue of large amounts of cutting waste. The invention solves this problem in that the material which is suitable in principle can be processed to give particle foam mouldings. These mouldings can be produced without reprocessing in short cycle times and hence economically. Furthermore, this gives rise to new means of functional integration, for example by direct incorporation of inserts etc. in the foam, and with regard to freedom in terms of design.

### PRIOR ART

Blends of PES and PPSU are indeed known for other industrial applications. For instance, EP 1 497 376 describes a corresponding blend for processing in the melt forming, in injection moulding, in compression moulding, in an extrusion or in blow moulding. However, it is not known that a foam can be produced from such a composition.

An alternative material which is already being installed as slab material in the aviation industry is poly(oxy-1,4-phenylsulfonyl-1,4-phenyl) (PESU). This is sold, for example, under the Divinycell F product name by DIAB, or Radel by Solvay. In the further processing of these extruded foam hoards, however, uneconomically large amounts of offcut material arise.

Porous membranes produced from such blends are also described, for example in EP 0 764 461. Membranes of this kind are produced by means of a casting method from an aqueous polymer composition.

Many foams used in industry have either drawbacks in the case of use at high temperatures or else non-optimal mechanical properties overall, and especially at these high temperatures. Furthermore, only very few existing foams are not extremely flammable and so qualify for installation in the interiors of road, rail or air vehicles for example. For example, PES foams have poor flame retardancy, while PPSU foams, for example, do not have optimum tear resistance.

Foams of PPSU or PES are known in principle, although not in a mixture with one another. For instance, L. Sorrentino: “Polymeric Foams from High-Performance Thermoplastics”, Advances in Polymer Technology, Vol. 30, No. 3, P. 234-243, 2011 (DOI 10.1002/adv) specifies corresponding studies for identification of ideal conditions for the foaming of PPSU or PES.

Blends containing either PPSU or PSE are likewise known, although details thereof are comparatively rare in the prior art. Thus, the two polymers are described more particularly as the minor component in the blend, for example in PS foams, in order to influence the properties in these commodity materials. Foams that contain PPSU or PES as the main component, by contrast, can only be found in a few descriptions, for example the following:

U.S. Pat. No. 4,940,733 describes a foam based on a blend of a polycarbonate and a second polymer which, among a multitude of other examples, may also be PES or PPSU. A foam of this kind does have high thermal stability, but does not have particularly good flame retardancy. Furthermore, there are no details of the mechanical properties.

WO 2015/097058 describes foams based on PPSU or PES, containing at least 10% by weight of a polyolefin. The phase-separating polyolefin probably acts primarily as a nucleating agent. This achieves more homogeneous pores, but without having a positive effect on the flame retardancy properties or mechanical properties, for example elongation at break. Owing to the phase separation, comparatively poor elongation at break if anything can actually be expected. With regard to the flame retardancy properties, a deterioration can likewise be expected as a result of the addition of a polyolefin component.

US 2013/0059933, US 2012/13599528 and EP 2 692 519 describe PS particle foams to which up to 10% by weight of another polymer, for example polyacrylates, has been added. Foams of this kind are all unsuitable in applications having fire retardancy requirements. In DE 102011110216, small amounts of polysulfones or polyether sulfones are also added to such a PS particle foam. Nevertheless, this foam too consists predominantly of PS, which entails corresponding disadvantages for applications in aviation.

### PROBLEM

The problem addressed by the present invention, with regard to the prior art, was that of providing a composition for production of novel foams or composite materials for use in aircraft construction. The resulting foams are to have a good combination of usability at high temperatures, good mechanical properties, especially with regard to the elongation at break, and at least sufficient flame retardancy for many applications in the field of vehicle and aircraft construction.

More particularly, the foam is to have high stability with respect to various liquid, acidic, basic or hydrophobic liquids, and with respect to emulsions.

Furthermore, the foam is to be realizable from the composition to be developed by a wide variety of different methods and with a wide range of three-dimensional shapes, and only very little offcut material, if any at all, is to arise in the production of the final component.

Further non-explicit problems may be apparent from the description, the claims or the examples in the present text, without having been explicitly recited here for this purpose.

### SOLUTION

The problems are solved by the provision of a novel composition for production of thermally stable foam materials of low flammability for use in lightweight construction, especially in the aviation industry, in shipbuilding, in the automobile industry or in rail vehicle construction. This inventive composition for production of foams is characterized in that it comprises a PESU particle foam which, as a foamed PESU, has a glass transition temperature between 180 and 215° C., and the mean cell diameter of the particle foam therein is less than 1000 μm, preferably less than 500 μm, more preferably less than 250 μm. In this context, a cell is understood to mean the region in a particle foam which is defined by foaming of an individual particle. This is especially surprising since the actual glass transition temperature of the PESU is 225° C.

According to the invention glass transition temperatures reported are measured by means of DSC (differential scanning calorimetry) unless otherwise stated. In this regard, those skilled in the art are aware that DSC is only sufficiently conclusive when, after a first heating cycle up to a temperature which is a minimum of 25° C. above the highest glass transition or melting temperature but at least 20° C. below the lowermost breakdown temperature of a material, the material sample is kept at this temperature for at least 2 min. Thereafter, the sample is cooled back down to a temperature at least 20° C. below the lowermost glass transition or melting temperature to be determined, where the cooling rate should be not more than 20° C./min, preferably not more than 10° C./min. After a further wait time of a few minutes, the actual measurement is effected, in which the sample is heated at a heating rate of generally 10° C./min or less up to at least 20° C. above the highest melting or glass transition temperature.

Preferably, the inventive composition for production of the PESU consists of 80% to 99.5% by weight of PESU. In addition, this composition includes 0.5% to 10% by weight, preferably 1% to 9% by weight, of a blowing agent. It may further contain inter alia 0% to 10% by weight, preferably 1% to 5% by weight, of additives.

The additives may especially be flame retardants, plasticizers, pigments, UV stabilizers, nucleating agents, impact modifiers, adhesion promoters, rheology modifiers, chain extenders, fibres and/or nanoparticles.

The flame retardants used are generally phosphorus compounds, in particular phosphates, phosphines or phosphites. Suitable UV stabilizers and/or UV absorbers are common general knowledge in the art. HALS compounds, Tinuvins or triazoles are generally used for this purpose. The impact modifiers used are generally polymer beads comprising an elastomeric and/or soft/flexible phase. These polymer beads frequently comprise core-(shell-)shell beads having an outer shell which, as such, is no more than lightly crosslinked and as purely polymer would exhibit at least minimal miscibility with the blend of PES and PESU. Any known pigments are employable in principle. Major amounts in particular do of course require testing as to their influence on the foaming operation, like all other additives employed in amounts above 0.1 wt %. This is not very burdensome to do for a person skilled in the art.

Suitable plasticizers, rheology modifiers and chain extenders are common general knowledge in the art of producing sheetings, membranes or mouldings from PES, PPSU or blends of the two, and are accordingly transferrable at minimal cost and inconvenience to the production of a foam from the composition according to the present invention.

The fibres are generally known fibrous materials for addition to a polymer composition. In a particularly suitable embodiment of the present invention, the fibres are PES fibres, PPSU fibres or blend fibres, the latter composed of PSE and PPSU.

Nanoparticles, for example in the form of tubes, platelets, rods, spheres or in other known forms, are inorganic materials in general. They may perform various functions in the final foam at one and the same time. This is because these particles act in part as nucleating agents in the foaming operation. The particles can further influence the mechanical properties as well as the (gas) diffusion properties of the foam. The particles further make an additional contribution to low flammability.

The recited nanoparticles aside, microparticles or largely immiscible, phase-separating polymers may also be included as nucleating agents. In the context of nucleating agents in the composition, the polymers described must be viewed separately from the other nucleating agents, since the latter primarily exert influence on the mechanical properties of the foam, on the melt viscosity of the composition and hence on the foaming conditions. The additional effect of a phase-separating polymer as a nucleating agent is an additional desired effect of this component, but not the primary effect in this case. Therefore, these additional polymers appear further up in the overall tally, separate from the other additives.

It is optionally also possible for the additives to include up to 9% by weight of a second polymer component for adjustment of the physical properties. The additional polymers may, for example, be polyamides, polyolefins, in particular PP, PEEK, polyesters, in particular PET, other sulfur-based polymers, for example PSU, polyetherimides or polymethacrylimide.

The choice of blowing agent is relatively free and for a person skilled in the art is dictated in particular by the foaming method chosen and the foaming temperature. Suitable examples are alcohols, e.g. isopropanol or butanol, ketones, such as acetone or methyl ethyl ketone, alkanes, such as isobutane, n-butane, isopentane, n-pentane, hexane, heptene or octane, alkenes, e.g. pentene, hexene, heptene or octene, CO₂, N₂, water, ethers, e.g. diethyl ether, aldehydes, e.g. formaldehyde or propanal, hydro(chloro)fluorocarbons, chemical blowing agents or mixtures of two or more thereof.

Chemical blowing agents are relatively or completely non-volatile substances which undergo chemical decomposition under foaming conditions to form the actual blowing agent upon decomposition. tert-Butanol is a very simple example thereof in that it forms isobutene and water under foaming conditions. Further examples are NaHCO₂, citric acid, citric acid derivatives, azodicarbonamide (ADC) and/or compounds based thereon, toluenesulfonylhydrazine (TSH), oxybis(benzosulfohydroazide) (OBSH) or 5-phenyltetrazole (5-PT).

Preferably, the PESU particle foam according to the invention has a tensile strength to ISO1926 of greater than 0.5 MPa, an elongation at break to ISO1926 of between 8% and 12%, a shear modulus to ASTM 0273 at room temperature of greater than 8 MPa, a shear resistance to ASTM 0273 at room temperature of greater than 0.45 MPa, a compressive modulus to ISO 844 at room temperature of greater than 13 MPa, and a compressive strength to ISO 844 at room temperature of greater than 0.4 MPa. In the case of employment of the process described further down for production of the PESU particle foam, it is a simple matter for the person skilled in the art to comply with these mechanical properties while maintaining the glass transition temperature and cell size according to the invention. In addition, it has also been found that, surprisingly, the particle foam according to the invention is usable with satisfaction of the fire protection specifications or fire properties according to FAR 25.852 that are of particular importance for use in the interior of an aircraft in the aviation industry.

It is also very surprising that all the material properties required that are a prerequisite for use in an aircraft interior are fulfilled by a PESU particle foam, just as they are by a corresponding foam in slab form. For PMI, for example, this relationship does not exist, since the conditions are fulfilled for this polymethacrylimide sheet material composed of a slabstock foam, whereas a particle foam would not be approved.

Preferably, the foams according to the invention have a degree of foaming that amounts to a reduction in the density with respect to the pure blend of between 1% and 98%, preferably between 50% and 97%, more preferably between 70% to 95%. The foam preferably has a density between 20 and 1000 kg/m³, preferably 40 and 250 kg/m³.

As well as the PESU particle foam, processes for production thereof are also part of the present invention.

In principle, there are two preferred methods for production of the PESU particle foams. In a first process variant, a composition consisting of 80% to 99.5% by weight of PESU, 0.5% to 10% by weight of blowing agent and 0% to 10% by weight of additives is processed by means of an extruder having a perforated plate to give foamed pellets. The temperatures between intake zone and screw tip are within a range between 180 and 380° C. In this case, there is usually no homogeneous temperature over this distance, but instead, for example, a gradient with rising temperature in conveying direction of the polymer melt. The temperature of the perforated plate is between 300 and 350° C., and the melt temperature on exit through the perforated plate is between 200 and 360° C. The loading with the blowing agent is generally effected in the extruder. The pellets then foam as they exit from the perforated plate. The pellets thus foamed are then preferably foamed further to give a particle foam.

In one variant of this embodiment, the composition on exit from the extruder can be guided into an underwater pelletizer. This underwater pelletizer is designed to have a combination of temperature and pressure such that foaming is prevented. This procedure provides a pellet material laden with blowing agent, which may later be expanded to the desired density by a renewed supply of energy and/or further processed into a bead foam workpiece by optional moulding.

In a second process variant for production of a PESU particle foam, a composition consisting of 90% to 100% by weight of PESU and 0% to 10% by weight of additives is processed by means of an extruder with a perforated plate likewise at first to give pellets, but is not laden with a blowing agent. Here too, the temperatures—which are again not necessarily uniform—between intake zone and screw tip are within a range between 180 and 380° C. The temperature of the perforated plate is likewise between 300 and 350° C., and the melt temperature on exit through the perforated plate is between 200 and 360° C. Here, the pellets are subsequently laden with a blowing agent in an autoclave in such a way that they contain between 0.5% and 10% by weight of blowing agent. The blowing agent-laden pellets can then be foamed by expansion and/or by heating to a temperature exceeding 200° C. to obtain a particle foam.

Various methods for the actual foaming polymeric compositions are known in principle by a person skilled in the art to be in principle applicable to the present composition particularly in respect of methods for thermoplastic foams, For example, the composition can be foamed at a temperature between 150 and 250° C. and at a pressure between 0.1 and 2 bar. Preferably, the actual foaming, if it does not follow after the extrusion, is effected at a temperature between 180 and 230° C. in a standard pressure atmosphere.

In the variant of the later loading with a blowing agent, a composition still without blowing agent is admixed with the blowing agent in an autoclave at a temperature, for example, between 20 and 120° C. and at a pressure, for example, between 30 and 100 bar and subsequently expanded inside the autoclave by reducing the pressure and raising the temperature to the foaming temperature. Alternatively, the composition admixed with the blowing agent is cooled down in the autoclave and deautoclaved after cooling. This composition is then expandable at a later date by heating to the foaming temperature. This may also take place, for example, under further moulding or in combination with other elements such as inserts or facing layers.

More preferably, the particle foam produced—irrespective of the process used—is subsequently adhesive-bonded, sewn or welded to a cover material. “Welded” means here that heating of the components gives rise to adhesion between the materials, for example through partial filling of open pores at the foam surface with cover material.

The cover material may comprise wood, metals, decorative films, composite materials, prepregs or other known materials.

In the case of later foaming of the PESU, for example after the loading with blowing agent in an autoclave, the particle foam produced can alternatively also be foamed in the presence of a cover material such that it is bonded thereto by means of adhesive bonding or welding.

In the process variant in which the loading with blowing agent is effected in an extruder, the PESU can alternatively also be applied on exit from the extruder into an optionally heated mould, optionally containing cover materials. In this case, foaming is effected with shaping to give a particle foam or a composite material. Alternatively, the composition, on exit from the extruder, can be guided into a foam spraying apparatus, In this apparatus, expansion then takes place directly with moulding.

Irrespective of the variants used, the particle foams or composite materials can be provided with inlets during the foaming and/or channels can be incorporated into the particle foam.

Foams according to the invention, or the foams produced by the process according to the invention, find use more particularly in the construction of spacecraft or aircraft, especially in the interior thereof. This may include the particle foams, whether produced by the process according to the invention or not, and likewise the composite materials realized therefrom. More particularly, by virtue of their low flammability, the foams of the present invention can also be installed in the interior of these vehicles.

In addition, the HT foams produced in accordance with the invention can be processed further to give foam mouldings or foam core composite materials. These foam mouldings or foam core composite materials may especially find use in mass production, for example for bodywork construction or for interior cladding in the automobile industry, interior parts in rail vehicle construction or shipbuilding, in the aerospace industry, in mechanical engineering, in the production of sports equipment, in furniture construction or in the construction of wind turbines.

1. A polyethersulfone (PESU) particle foam, comprising:
foamed PESU, which has a glass transition temperature between 180 and 215° C., and
wherein a mean cell diameter of the PESU particle foam is less than 1000 μm.

2. The PESU particle foam according to claim 1, obtained from a composition comprising:
80% to 99.5% by weight of PESU,
0.5% to 10% by weight of a blowing agent, and
0% to 10% by weight of additives.

3. The PESU particle foam according to claim 2, wherein the additives are flame retardants, plasticizers, pigments, UV stabilizers, nucleating agents, impact modifiers, adhesion promoters, rheology modifiers, chain extenders, fibres, nanoparticles, or combinations thereof.

4. The PESU particle foam according to claim 2, wherein the blowing agent is an alcohol, a ketone, an alkane, an alkene, CO₂, N₂, water, an ether, an aldehyde, chemical blowing agents or mixtures of two or more thereof.

5. The PESU particle foam according to claim 1, having:
a tensile strength, according to ISO1926, of greater than 0.5 MPa,
an elongation at break, according to ISO1926, of between 8% and 12%,
a shear modulus, according to ASTM 0273, at room temperature of greater than 8 MPa,
a shear resistance, according to ASTM C273, at room temperature of greater than 0.45 MPa,
a compressive modulus, according to ISO 844, at room temperature of greater than 13 MPa, and
a compressive strength, according to ISO 844, at room temperature of greater than 0.4 MPa.

6. The PESU particle foam according to claim 1, wherein the PESU particle foam is suitable for lightweight construction in the aviation industry, in shipbuilding, in the automobile industry or in rail vehicle construction.

7. A process for producing the PESU particle foam according to claim 1, said process comprising:
processing a composition comprising:
80% to 99.5% by weight of PESU,
0.5% to 10% by weight of blowing agent, and
0% to 10% by weight of additives,
with an extruder with a perforated plate to give foamed pellets,
wherein the temperatures between intake zone and screw tip are within a range between 180 and 380° C., the temperature of the perforated plate is between 300 and 350° C., and the melt temperature on exit through the perforated plate is between 200 and 360° C., and
subsequently further foaming the foamed pellets to give the PESU particle foam.

8. A process for producing the PESU particle foam according to claim 1, said process comprising:
processing a composition comprising:
90% to 100% by weight of PESU, and
0% to 10% by weight of additives,
with an extruder with a perforated plate to give pellets,
wherein the temperatures between intake zone and screw tip are within a range between 180 and 380° C., the temperature of the perforated plate is between 300 and 350° C., and the melt temperature on exit through the perforated plate is between 200 and 360° C.,
subsequently loading the pellets with a blowing agent in an autoclave in such a way that the pellets comprise between 0.5% and 10% by weight of the blowing agent, and
foaming the blowing agent-laden pellets by expansion and/or by heating to a temperature exceeding 200° C. to give the PESU particle foam.

9. A process for producing a composite part, comprising:
bonding, sewing, or welding the PESU particle foam, produced by the process according to claim 7, to cover materials.

10. A process for producing a composite part, comprising:
foaming the PESU particle foam produced by the process according to claim 8 in the presence of a cover material in such a way that the PESU particle foam is bonded thereto by adhesive bonding or welding.

11. The process according to claim 7, wherein the PESU on exit from the extruder is introduced into an optionally heated mould, optionally comprising cover materials, and foamed with shaping to give the PESU particle foam or a composite material.

12. The process according to claim 7, wherein inlets and/or channels are incorporated into the PESU particle foam during the foaming.

13. A process of aircraft construction, comprising:
incorporating the PESU particle foam produced according to claim 7 into the aircraft construction.

14. A process of aircraft construction, comprising:
incorporating the composite part produced according to claim 9 into the aircraft construction.
